(19) United States
(12) Patent Application Publication
(10) Pub. No.: US 2010/0077456 A1
(43) Pub. Date: Mar. 25, 2010

(54) OPERATOR DEVICE PROFILES IN A SURVEILLANCE SYSTEM

(75) Inventors: Marine Drive, Bangalore (IN); Deepakumar Subbian, Bangalore (IN); Shanmugam Selvarajan, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/197,656

(22) Filed: Aug. 25, 2008

(51) Int. Cl. G06F 21/20; G06F 3/048; G06F 17/30; H04N 7/18

(52) U.S. Cl. 726/4; 715/734; 707/827; 348/143; 707/E17.009; 348/E07.085

(57) ABSTRACT

The present invention provides systems and methods for allowing an administrator to create device profiles, and map specific device profiles to specific operators. The system comprises a surveillance device to record an event, an administrator station for receiving a data stream corresponding to the event and for assigning the data stream to a device profile based on a plurality of attributes in the metadata of the stream, and a broadcast engine for mapping the data stream alongside a plurality of data streams within the device profile to an operator station. The method comprises recording an event within a secure area via a surveillance device, generating a data stream corresponding to the recorded event, applying a plurality of attributes for the data stream, transmitting the data stream to an administrator station, assigning the data stream to a device profile based in part on the plurality of attributes for the data stream, and mapping the data stream along with a plurality of data streams within the device profile to an operator station over a network.

### FIELD OF THE INVENTION

The present invention relates generally to surveillance systems. Specifically, the present invention relates to grouping a plurality of surveillance data streams into profiles and mapping the profiles to operator stations.

### BACKGROUND OF THE INVENTION

Surveillance and alarm systems are commonly used in secure areas to protect against intruders and other alarm events. Various conventional centralized surveillance and alarm systems are known that provide surveillance features and options to protect the secure areas. A plurality of sensors detects abnormal conditions, and reports the conditions to a local monitoring station or to a central monitoring station. For instance, a plurality of digital Closed-Circuit Television (CCTV) cameras may monitor different areas of a secure building such as a museum and generate a data stream comprising the video feed along with other information.

The data stream generated by a sensor is typically transmitted to a control panel, or directly to an operator station, whereupon it may be monitored by an operator, or reported to a central monitoring station. In the CCTV example, a video stream may be transmitted to one or more monitors at an operator station, with an operator reviewing the footage for irregularities. In another example, multiple video streams are streamed to a plurality of monitors arranged in a grid-like fashion. This may be termed a “monitor wall” or “display layout.” The operator views the display layout and may have the ability to configure which feed is delivered to which monitor. In addition, an administrator controls the routing of the data streams, being able to modify the headers of specific data streams and route them to specific operator stations via an administrator station.

As surveillance systems get larger and more complex, thousands of devices may be providing data streams to a plurality of operator stations. An administrator would be overloaded trying to group and share devices of interest or particular data streams to specific operators. In emergency or unique situations, an administrator needs the ability to deploy a plurality of data streams to a specific operator instantly. With the advent of digital cameras and sensors that are able to communicate across wired and wireless packet-based networks such as the Internet, there is potential for tremendous advancements in the ability to monitor and control several secure areas and surveillance systems from a remote location. However, this functionality is not being utilized to its maximum potential.

### SUMMARY OF THE INVENTION

The present invention solves the difficulties involved in assigning devices and data streams to specific operators by allowing an administrator to create device profiles, and map specific device profiles to specific operators.

In one embodiment, the present invention is a surveillance system for monitoring a secure area, the system comprising a surveillance device to record an event occurring within the secure area, a first logic unit coupled to the surveillance device to generate a data stream corresponding the recorded event, a transceiver in communication with the surveillance device for transmitting the data stream over a network, a second logic unit for receiving the data stream and for assigning the data stream to a device profile, and a broadcast engine in communication with the second logic unit for mapping the data stream alongside a plurality of data streams within the device profile to an operator station. The surveillance system further comprises a plurality of attributes for the data stream, wherein the second logic unit assigns the data stream to the profile based in part on the plurality of attributes for the data stream.

A first database in communication with the first logic unit contains a record for the data stream, wherein each record includes the plurality of attributes for the data stream. The plurality of attributes for the data stream is included within a metadata for the data stream.

The second logic unit may be part of an administrator station, and a second database in communication with the second logic unit stores the device profile, wherein the profile is defined by an administrator of the system. The administrator maps the surveillance devices within a device profile to a specific operator station in response to the occurrence of an event or a condition. Alternatively, the surveillance devices within a device profile are automatically mapped to a specific operator station in response to the occurrence of an event or a condition. The second logic unit maps the data stream to the operator station only if a user of the operator station has a permission to access the data stream.

The surveillance system further comprises a Graphical User Interface (GUI) coupled to the operator station for displaying a device tree, the device tree listing the plurality of data streams within the device profile mapped to the operator station. A user of the operator station can define a group of favorite surveillance devices from the device tree.

In a related embodiment, the plurality of surveillance devices comprises analog cameras, digital cameras, CCTV cameras, motion-sensing cameras, still cameras, or any combination thereof. The data stream for each of the plurality of surveillance devices comprises stream-wise video clips, time-wise video clips, still images, and combinations thereof. The plurality of attributes for the data stream comprises one or more of the following: a display position within a display layout, a scan sequence, a salvo, a target, access privileges, and a user-defined attribute.

In another embodiment, the present invention is a method for monitoring a secure area, the method comprising recording an event within the secure area via a surveillance device monitoring the secure area, generating a data stream corresponding to the recorded event, applying a plurality of attributes for the data stream, transmitting the data stream to an administrator station, assigning the data stream to a device profile based in part on the plurality of attributes for the data stream, and mapping the data stream along with a plurality of data streams within the device profile to an operator station over a network. The method further comprises generating a metadata for the data stream, the metadata including the plurality of attributes for the data stream. The method further comprises defining a device profile based on a plurality of pre-defined attributes, and storing the device profile on a database in communication with the administrator station.

The mapping of the data streams within a device profile to the operator station is performed by an administrator in response to the occurrence of an event or a condition. Alternatively, the mapping of the data streams within a device profile to the operator station is performed automatically in response to the occurrence of a predefined event or condition. The method further comprises verifying that a user of the operator station has a permission to access the data stream before mapping the data stream to the operator station.

A Graphical User Interface (GUI) coupled to the operator station displays a device tree comprising a list of all the data streams mapped to the operator station. An operator may define a group of favorite surveillance devices from the device tree.

### BRIEF DESCRIPTION OF THE DRAWINGS

FIG. 1 shows a surveillance system on a network, according an exemplary embodiment of the present invention.

FIG. 2 shows a method for monitoring a secure area according to an exemplary embodiment of the present invention.

FIG. 3 shows a use-case scenario of a surveillance system according to an exemplary embodiment of the present invention.

### DETAILED DESCRIPTION OF THE EMBODIMENTS

The present invention provides systems and methods for allowing an administrator to create device profiles, and map specific device profiles to specific operators.

For the purposes of the present invention, a surveillance system comprises a plurality of surveillance sensors or devices, servers, terminals, and software, all in communication over a wired or wireless network. The surveillance system may further include transceivers for each device or server/terminal to enable said communication. The surveillance system may further include control panels, operator stations, administrator stations, and central monitoring stations.

Surveillance sensors and surveillance devices comprise any device that detects changes within or monitors a secure area. Sensors monitor visual or aural aspects of a secure area, for instance by video cameras, motion sensors, sound sensors, etc. Heat, smoke, carbon monoxide (CO), and related sensors are also included. A secure area is any compound, building, room within a building, or specific area that is within the range of a surveillance sensor. For instance, a CCTV camera monitoring a hallway is a surveillance sensor and the hallway is the secure area. A secure area may be monitored by more than one sensor. A plurality of secure areas monitored by a surveillance system comprising a plurality of surveillance sensors comprises a secure site.

A surveillance sensor generates a data stream that is a quantitative representation of the events monitored by the surveillance sensor. For instance, a video feed from a surveillance camera is a data stream. In a packet-based system, the data stream is a plurality of packets, each having its own metadata. The metadata includes various attributes related to the data stream. The attributes may include the following information: a) data stream configuration settings such as resolution, frames per second (for video), compression, and network settings, b) type of data stream such as network streaming feed, or composite feed via coaxial cable, c) connection details including storage paths, and d) user preferences on video display settings, layouts, display modes, etc. Metadata also include checksums, privilege/permission details for the data stream, rules and actions related with the data stream, date and time of recording, and events and alarms associated with the data stream (for instance, whether or not the data stream was recorded in response to an event or simply a normally scheduled recording, and so on). Recording in response to an event includes motion-activated recording, in which case the metadata includes that the data stream was generated in response to motion. The metadata is incorporated into the data stream in the form of a header.

In the case of analog surveillance devices, the surveillance device may transmit the analog data stream to a local control panel, via a fixed or wireless network, radio, or electrical/coaxial transmission cables. The local control panel digitizes the data stream and transmits it across the network.

An administrator station may receive the data stream and perform operations upon it, as described in the below embodiments. An administrator station comprises a plurality of workstations, transceivers, and databases. A single workstation comprises a transceiver, input/output devices, and a display. An administrator of the surveillance system can modify headers and metadata of incoming data streams, and re-route them to specific operator stations as described herein. An operator station is also a plurality of workstations that receive data feeds via transceivers. Operator stations typically comprise Graphical User Interfaces (GUIs) that provide various user-definable layouts to display incoming data streams. Operator stations may also provide means for remotely controlling the surveillance devices generating the stream.

A central monitoring station is a remotely located collection of servers that provides control of one or more surveillance systems. A central monitoring station may receive a plurality of data streams, as well as responses to events detected within the data streams. For instance, a central monitoring station would receive a data stream, and an operator's acknowledgement of an event witnessed within the data stream. The central monitoring station would be in communication with the appropriate means for remedying or reacting to the event, such as contacting an emergency vehicle in response to an accident.

The present invention will now be described below in reference to the figures. Although the surveillance systems and methods are shown with respect to CCTV cameras and video monitoring stations, other types of sensors can be implemented.

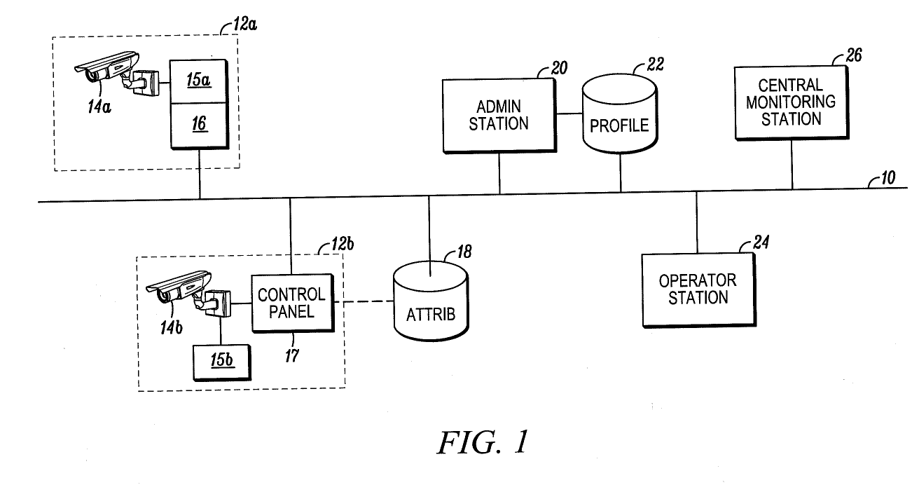

FIG. 1 shows a surveillance system according to an exemplary embodiment of the present invention. A network 10 provides connectivity between elements. Secure areas 12a and 12b are respectively monitored by cameras 14a and 14b. Cameras 14a and 14b generate data streams that are transmitted via network 10. In secure area 12a, camera 14a is equipped with its own logic unit 15a for generating a metadata for the data stream, as well as a transceiver 16a for transmitting the data stream across network 10. Secure area 12b has a camera 14b equipped with a logic unit 15b for generating a data stream. Camera 14b is not network-capable, thus transmits its data stream to a control panel 17 that is shown to be within the vicinity of area 12b. In one embodiment, control panel 17 may also add metadata to the data stream before transmitting over the network 10. Metadata comprises a plurality of attributes for the data stream, as described herein. These attributes may be stored in an attribute database 18, also in communication with the network 10.

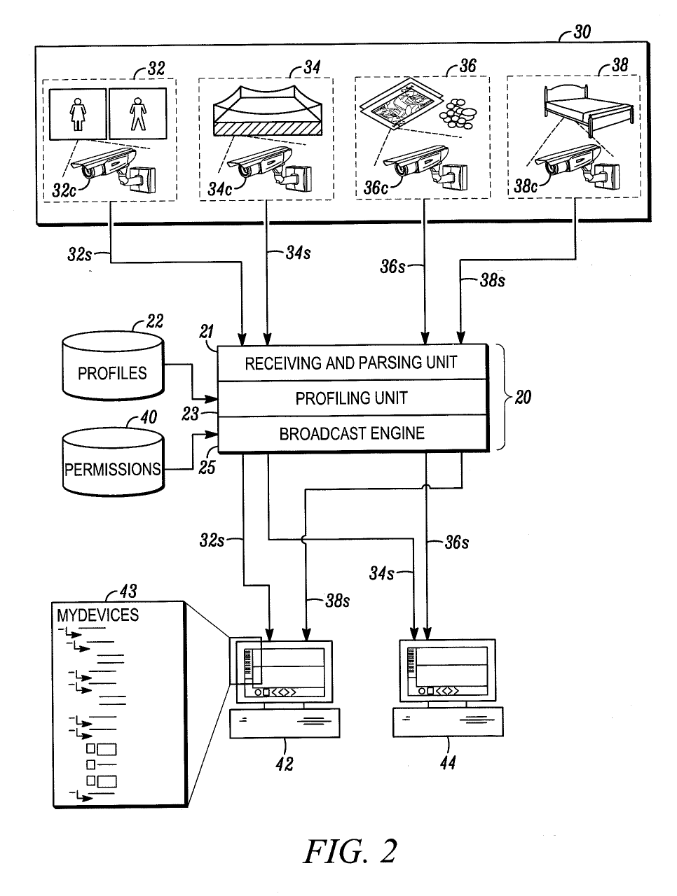

The data streams are received by an administrator station 20. Administrator station 20 comprises a plurality of logic units 21, 23, 25, and databases. As shown in more detail in FIG. 2, administrator station 20 includes a receiving unit 21 to receive the data stream and parse the metadata to retrieve the attributes of the data stream. A profiling unit 23 matches these attributes to those listed in a device profile. Device profiles are user-generated and may be stored in a profile database 22. Device profiles list specific attributes that allow the profiling unit to match incoming data streams with said device profile. For instance, an “outdoors” profile may include any data stream generated by an outdoors camera. Since the source information of a data stream is stored in the metadata of the data stream, the profiling unit 23 would match this information with the user-defined “outdoors” profile, and assign the incoming data stream to that profile. Many other combinations will be apparent to one skilled in the art.

Administrator station 20 also includes a broadcast engine 25 for mapping the data streams within specific profiles to operator stations 24. This mapping may be manually accomplished by an administrator, or may be based on pre-defined rules. The broadcast engine 25 will enable a user of an operator station 24 (FIG. 1) to view the profiled data streams. The broadcast engine 25 may also check with a permissions database 40 to determine if the operator is privileged to access the data stream. The operator station 24 comprises a plurality of logic units, and a Graphical User Interface (GUI) allowing the operator to view and interact with the incoming data streams. The GUI provides a “device tree” or list of available devices that the operator can select and view within a plurality of windows provided by the GUI. The profiling and broadcasting functions of the administrator station 20, and the GUI of operator station 24 are further described in FIG. 2.

As described above, the embodiment in FIG. 1 shows cameras, but the sensors may be any surveillance or security sensors known in the art, such as smoke or carbon monoxide (CO) detectors, burglar alarms, motion sensors, etc. The cameras themselves may be any type of visual recording device known in the art, including but not limited to CCTV and/or still cameras. The cameras may be equipped with transceivers to communicate over a wired or wireless network. The cameras may have motion-sensing capabilities, as well as image recognition either onboard the camera itself or as separate logic in communication with the camera, such as logic within control panel 17, which appends the data stream with metadata in the form of a packet header.

A device profile within profile database 22 provides the administrator with a means for grouping devices according to the attributes within the data stream generated by the device. For instance, device profiles may include all devices the monitor hallways of a secure site. Device profiles can also include surveillance devices having specific features, such as motion-sensing devices or scan sequences across a plurality of surveillance devices. Device profiles may further include salvos. A Salvo a specification of a monitor, a view or display layout, and a speed expressed as a time interval by which a positioning system should implement the view, given that such movement is necessary. Specific salvos within a device profile can be mapped to specific operators, according to an exemplary embodiment of the present invention.

Communication between elements takes place over fixed or wireless networks, such as a local, wide-area, or Internet network. For instance, camera 14b may transmit its data stream to control panel 16 via a network that includes the potential for wireless communication over wi-fi or Bluetooth. Control panel 16 (and camera 14a) would be capable of communicating over a wide-area network or ubiquitous packet-based network such as the Internet. Each camera, control panel, monitoring station, and sub-elements thereof would have their own unique address on the Internet. In one embodiment, every element is equipped with a transceiver (not shown) and has a unique Session Initiation Protocol (SIP) or Internet Protocol (IP) address.

FIG. 2 shows an exemplary embodiment of the present invention as used in a hypothetical situation in a casino. The casino is represented by secure site 30. Secure site 30 comprises secure areas 32, 34, 36, and 38. Secure site 32 represents one or more restrooms within the casino 30, wherein each restroom is monitored by a camera 32c that generates a data stream 32s, 32c and 32s may represent a plurality of cameras and a plurality of data streams, respectively. Similarly, secure area 34 is a boxing arena within casino 30, and is monitored by one or more of cameras 34c generating data streams 34s. Secure area 36 represents playing tables, monitored by cameras 36c generating data streams 36s. Finally, secure area 38 represents hotel rooms monitored by cameras 38c generating data streams 38s.

Cameras 32c, 34c, 36c, and 38c are in communication with, inter alia, an administrative station 20. As described above, administrative station 20 comprises a receiving unit 21 that also parses the metadata of incoming data streams, a profiling unit 23, and a broadcast engine 25. Administrative station 20 is also in communication with profile database 22 and permissions database 40. Also in communication with administrative station 20 are operator stations 42 and 44. As can be seen in FIG. 2, operator stations 42 and 44 comprise a GUI that is arranged in a grid-like fashion, with visual representations of the data streams displayed in windows, and a selection area showing a device tree 43.

In one scenario, a major boxing match is to take place within casino 30. In such a scenario, an administrator would want to group high-priority areas to one operator station such as one monitored by a plurality of experienced operators, while grouping lower-priority areas to a less-experienced operator.

Data streams 32s, 34s, 36s, and 38s have attributes appended into a header/metadata of the data stream, either by the respective camera or by a control panel (not shown). A list of all attributes may be stored in an attribute database, accessible by the camera or by the control panel. Data streams 32s, 34s, 36s, and 38s arriving at administrator station 20 are presumed to have attributes appended to them. At the administrator station 20, the data stream is matched with a plurality of device profiles, and assigned to the ones being matched. The device profiles may be user-defined and stored in profile database 22. In the present case, profiling unit may seek to match data streams marked with an attribute “tenant: customers” to the “customers” device profile. Alternatively, cameras 34c and 36c may be higher-resolution cameras to be able to observe specific activities at high zoom. Then an administrator may want to profile these devices as being with a higher resolution, and broadcast/map them to a larger display unit within one of the operator stations.

Thus, all data streams that need priority monitoring are mapped to operator station 64. The lower priority data streams (in this case, for secure areas 32 and 38) are mapped to operator station 42. This mapping could be automated, or may be initiated by the administrator in response to the beginning of the boxing match, or alternatively could be automated or scheduled in advance by the administrator. As described earlier, before the data streams are mapped to the operator stations, a permissions check may be invoked to determine whether or not the specific operator is privileged to view the specific data stream. The permissions check includes checking the header/metadata of the data stream for any related attributes and comparing them to a permissions database 40.

The GUI on operator stations 42 and 44 provides a list of available devices to be viewed. A representative “device tree” 43 is shown. The operator may drag and drop devices into the windows in the GUI and create custom-made layouts of data streams. In addition, administrator-defined display layouts may be remotely provisioned into operator stations 42, 44 for access by the operator. The operator may also group the data streams based on the attributes within the metadata of the data stream. The operator may further have the ability to control the features of the surveillance sensors, said ability to control being provided by commands in the GUI. For example, a camera may be mounted such it can change its field of view by zooming in or pivoting, via a motor control. Other commands may include focusing, open/close iris, washout, wipe, etc. In this case, such movements can be controlled remotely using an appropriate control and communication scheme, provided via the GUI in operator stations 42, 44. Thus, control of surveillance systems in a plurality of remote locations is provided by the operator station.

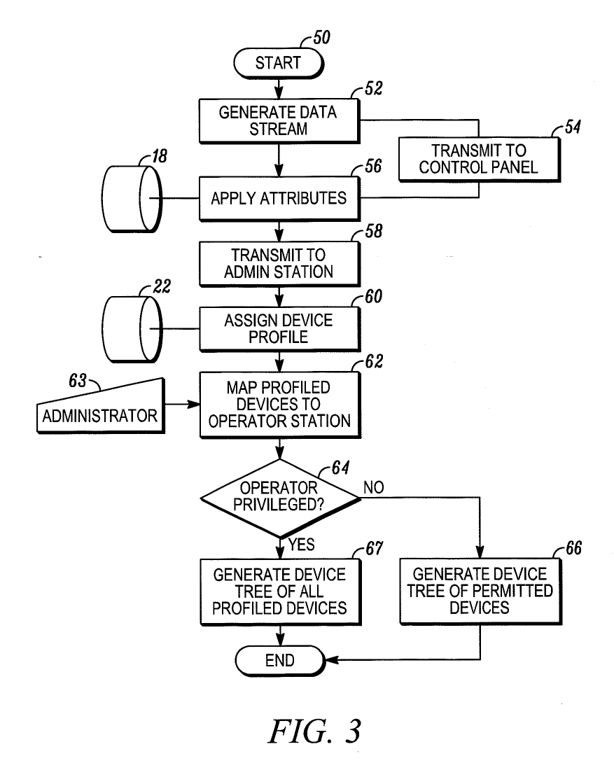

FIG. 3 shows the method steps according to an exemplary embodiment of the present invention. Start (50) represents an indefinite point in time before a data stream is generated (52) by a sensor, such as camera 14. Attributes are appended (56) to a header/metadata of the data stream. Optionally, camera 14 may transmit (54) the data stream to a control panel before attributes are applied (56). Attributes that are appended to the metadata may be stored in an attribute database 18, accessible by the camera or by the control panel.

The data stream (with metadata) is then transmitted (58) to an administrator station whereby it undergoes steps (60) to (62). The data stream is matched with a plurality of device profiles, and assigned (60) to successful matches. The device profiles may be user-defined and stored in profile database 22. All data streams within a particular profile may be mapped (62) or enabled via the network to specific operator stations. This mapping could be automated, or may be initiated by an administrator (63) in response to the happening of an event. For instance, if a boxing match were to take place in a casino, an administrator could map every data stream tagged with the attribute “Tenant: customers” to a specific operator to monitor the data streams. In this case, the target or “tenant” of the sensors/cameras would be the customers of the casino, who most likely congregate around either the boxing ring or the casino tables. Such an example was described in further detail in FIG. 2.

Before the data streams are mapped (62) to operator stations, a permissions check may be invoked (64) to determine whether or not the specific operator is privileged to view the specific data stream. For instance, a low-level operator may not be permitted to view a video feed from a camera inside a bank vault. This permissions check provides a second layer of security to the system. If an operator is fully privileged, the GUI at the operator station displays (66) a device tree of all devices within the profile. If, however, an operator is not fully privileged, only permitted devices are included (67) in the device tree at the operator's GUI.

While preferred embodiments of the present invention have been described using specific terms, such description is for illustrative purposes only, and it is to be understood that changes and variations may be made without departing from the spirit or scope of the following claims.

1) A surveillance system for monitoring a secure area, the system comprising:
a surveillance device to record an event occurring within the secure area;
a first logic unit coupled to the surveillance device to generate a data stream corresponding the recorded event;
a transceiver in communication with the surveillance device for transmitting the data stream over a network;
a second logic unit for receiving the data stream and for assigning the data stream to a device profile; and
a broadcast engine in communication with the second logic unit for mapping the data stream alongside a plurality of data streams within the device profile to an operator station.

2) The surveillance system of claim 1, wherein the second logic unit assigns the data stream to the profile based in part on a plurality of attributes for the data stream.

3) The surveillance system of claim 2, further comprising:
a first database in communication with the first logic unit, the first database containing a record for the data stream, wherein each record includes the plurality of attributes for the data stream.

4) The surveillance system of claim 3, wherein the plurality of attributes for the data stream is included within a metadata for the data stream.

5) The surveillance system of claim 2, wherein the second logic unit is part of an administrator station, the system further comprising:
a second database in communication with the second logic unit to store the device profile, wherein the profile is defined at the administrator station.

6) The surveillance system of claim 5, wherein the surveillance devices within a device profile are mapped at the administrator station to a specific operator station in response to the occurrence of an event or a condition.

7) The surveillance system of claim 5, wherein the surveillance devices within a device profile are automatically mapped to a specific operator station in response to the occurrence of an event or a condition.

8) The surveillance system of claim 2, wherein the second logic unit maps the data stream to the operator station only if a user of the operator station has a permission to access the data stream.

9) The surveillance system of claim 2, further comprising:
a Graphical User Interface (GUI) coupled to the operator station for displaying a device tree, the device tree listing the plurality of data streams within the device profile mapped to the operator station.

10) The surveillance system of claim 9, wherein a user of the operator station can define a group of favorite surveillance devices from the device tree.

11) The surveillance system of claim 2, wherein the plurality of surveillance devices comprises analog cameras, digital cameras, CCTV cameras, motion-sensing cameras, still cameras, or any combination thereof.

12) The surveillance system of claim 11, wherein the data stream for each of the plurality of surveillance devices comprises stream-wise video clips, time-wise video clips, still images, and combinations thereof.

13) The surveillance system of claim 12, wherein the plurality of attributes for the data stream comprises one or more of the following: a display position within a display layout, a scan sequence, a salvo, a target, access privileges, and a user-defined attribute.

14) A method for monitoring a secure area, the method comprising:
recording an event within the secure area via a surveillance device monitoring the secure area;
generating a data stream corresponding to the recorded event;
applying a plurality of attributes for the data stream;
transmitting the data stream to an administrator station;
assigning the data stream to a device profile based in part on the plurality of attributes for the data stream; and
mapping the data stream along with a plurality of data streams within the device profile to an operator station over a network.

15) The method of claim 14, further comprising:
generating a metadata for the data stream, the metadata including the plurality of attributes for the data stream.

16) The method of claim 14, further comprising:
defining a device profile based on a plurality of pre-defined attributes; and
storing the device profile on a database in communication with the administrator station.

17) The method of claim 16, wherein the mapping of the data streams within a device profile to the operator station is performed by an administrator in response to the occurrence of an event or a condition.

18) The method of claim 16, wherein the mapping of the data streams within a device profile to the operator station is performed automatically in response to the occurrence of a predefined event or condition.

19) The method of claim 14, further comprising:
verifying that a user of the operator station has a permission to access the data stream before mapping the data stream to the operator station.

20) The method of claim 14, further comprising:
displaying a device tree on a Graphical User Interface (GUI) coupled to the operator station, the device tree comprising a list of all the data streams mapped to the operator station.

21) The method of claim 20, further comprising:
defining a group of favorite surveillance devices from the device tree.

22) The method of claim 14, wherein the surveillance device comprises an analog camera, digital camera, CCTV camera, motion-sensing camera, still camera, or any combination thereof.

23) The method of claim 22, wherein the data stream for the surveillance device comprises stream-wise video clips, time-wise video clips, still images, and combinations thereof.

24) The method of claim 23, wherein the plurality of attributes for the data stream comprises one or more of the following: a display position within a display layout, a scan sequence, a salvo, a target, access privileges, and a user-defined attribute.
